(19) United States
(12) Patent Application Publication
(10) Pub. No.: US 2021/0214960 A1
(43) Pub. Date: Jul. 15, 2021

(54) NON-PENETRATING ROOF ANCHOR

(71) Applicant: TIM PRICE, INC. DBA CONTACT! CORPORATION, Winchester, VA (US)

(72) Inventors: Tim PRICE, Jefferson Hills, PA (US); Fred H. Alger, Berryville, VA (US)

(21) Appl. No.: 17/143,812

(22) Filed: Jan. 7, 2021

Related U.S. Application Data
(60) Provisional application No. 62/958,953, filed on Jan. 9, 2020.

(51) Int. Cl. E04G 21/32

(52) U.S. Cl. CPC E04G 21/3276

(57) ABSTRACT

Non-penetrating roof anchor brackets are described, and may be used in combination with an easily adjustable guy wire or guy rope leading to the top of a support structure, such as a mast, tripod, and other vertical structures. Some embodiments are L-shaped bracket anchors that fits over the outer edge of a roof or parapet. Embodiments of the bracket may include provisions to attach ballast to counter-balance guy rope forces. Some embodiments of the may be approximately crescent shaped, resembling an archery bow under tension, to provide a high strength to weight ratio, while conferring other significant benefits. Embodiments of the bracket may feature high friction surfaces and/or provision to rapidly attach counterweights.

### RELATED APPLICATIONS

This application claims priority to U.S. Provisional Patent Application No. 62/958,953, filed Jan. 9, 2020, the entire contents of each of which are hereby incorporated by reference.

### STATEMENT REGARDING GOVERNMENT SUPPORT

None.

### FIELD

The present disclosure relates to a non-penetrating anchor and associated guying system for temporary structures on flat roofs whereby the common practice of using heavy objects as ballast is improved by non-penetrating anchors used to secure guy wires/ropes attached to the structure.

### BACKGROUND

Military, Emergency and Commercial agencies use transportable masts to set up tactical/temporary line of sight communications, due to the increased line of sight range and reduced signal path obstructions obtained by elevating their radio antennas above ground level. These temporary communications users often have opportunities to obtain the line of sight range and unobstructed signal path they need simply by setting up their equipment on flat roofs, especially in an urban or suburban scenario. In these situations, a simple antenna support tripod may be used, thus avoiding the inconvenience and time associated with deploying a transportable mast.

Under windy conditions, it is generally necessary to secure and stabilize such temporary support structures to prevent equipment damage and to provide adequate antenna or sensor pointing accuracy for assured service reliability. Typical military specifications for tactical communications equipment call for reliable operation at a wind speed of 60 mph, with a survival wind speed of 80 mph (equivalent to category 1 hurricane conditions).

Communications crews frequently use sandbags to stabilize tripods as a “field expedient” measure, placing three or four bags on each foot. Twelve filled sandbags weigh about 600 pounds, requiring significant effort in a roof top scenario since all equipment needs to be transported up to roof level. In addition, sandbags are time consuming to fill. Unfortunately, sandbags placed on tripod feet are mechanically inefficient, are unable to prevent sway and twist of the antenna payload under windy conditions, and, unless used in much larger quantities, do not prevent tripod tip-over in the strong wind speeds frequently specified for military equipment.

Guy wires or guy ropes are commonly used to secure and stabilize antenna support structures because they offer a lightweight, effective solution. For temporary roof-mounted communications tripods, guy ropes may be attached directly to the payload support structure at the top of the tripod. This geometry is far more efficient than using ballast at the foot of the structure, since guy rope loads act at the point of maximum mechanical advantage. Of course, guy ropes require secure anchoring opposite the antenna support structure. This requirement has been a challenge to modern systems, and contemporary solutions have significant limitations. For example, contemporary solutions for anchoring guy ropes are, at best, either destructive to the structure, or highly inefficient in requiring heavy loads on the structure's roof that provide both an anchoring option and sufficient weight to stabilize the antenna support structure throughout the range of conditions.

Non-penetrating roof anchors are commercially available from a wide range of suppliers. These anchors are specifically intended for fall prevention and/or fall arrest for those engaged in activities requiring access to roofs. They are not designed or intended for anchoring guy wires or guy ropes, nor are they suited to such applications. Some of these anchors, working on the principle of counter-weight to prevent or mitigate personnel accidents, are heavy (typical assembled weight around 700 pounds), bulky, and time-consuming to assemble. They are expensive—often more than $3,000. Compounding the problem, a minimum of three such anchors would be necessary to provide three-dimensional stability of an antenna support tripod subjected to strong winds.

Other temporary, non-penetrating anchors are specifically designed for use on a sloping roof, and rely for secure operation on their ability to grip securely onto the roof eaves. Clearly, these anchors are unsuited to flat roofs or parapets, where there are no projecting eaves on which to grip.

Temporary non-penetrating parapet anchors are also widely available. These types of anchors are used to support equipment and personnel, such as window cleaners, suspended outside buildings below roof level. Many of these systems are limited to supporting loads below the roof, and are not designed to support structures protruding upward from the rooftop, particularly where high wind is an issue. And while some types of parapet anchors are suitable for use with guy ropes and guy wires, they cannot be used on roofs where there is no parapet. As a result, parapet anchors cannot confidently be relied upon for use with military, emergency or other temporary communications systems where conditions at the deployment site are unknown beforehand.

What is now needed is a cost-effective, lightweight, robust, rapidly deployable non-penetrating anchor designed for use with a heavily loaded guy wire or guy rope on a flat roof, whether a parapet is present or not. Such an anchor would fulfill the need to support and stabilize temporary communications and similar equipment on a flat roof under the very strong wind conditions required by the military and others for worldwide use.

### BRIEF SUMMARY

Described herein are embodiments of an L-shaped bracket anchor which fits over the outer edge of a flat roof or parapet, and which is used in combination with an easily adjustable guy wire or guy rope leading to the top of a support structure, such as a mast, tripod, or other vertical structure extending upward. The support structure may be, for example, a temporary antenna, portable communications array, tower, among other possible structures. Embodiments of the bracket may include provisions to attach ballast to counter-balance guy rope forces. Some embodiments of the L-shaped bracket may be approximately crescent shaped to provide a high strength to weight ratio, while conferring other significant benefits. Embodiments of the bracket may feature high friction surfaces and/or provision to rapidly attach counterweights.

Some embodiments of a non-penetrating roof bracket anchor include a first arm having a first distal end with a first connection hole configured for connection to a guy, and a first proximal end terminating at an internal bend; and a second arm having a second distal end and a second proximal end terminating at the internal bend opposite the first arm. The internal bend may be configured to abut an outer edge of one of a roof and a parapet, such that the first arm extends horizontally inward from the outer edge, and the second arm extends vertically downward from the outer edge. The first arm may connect to a guy, such as a rope or tether, and used to provide stability to a structure on the roof connected to the guy. Multiple non-penetrating roof bracket anchors may be combined to stabilize and secure the structure. For example, a non-penetrating roof bracket may be positioned along each edge of the rooftop.

In some embodiments, the first arm may have a first tab bent in a direction opposite of the internal bend and including the first connection hole. In some embodiments, the non-penetrating roof bracket anchor may have an arcuate profile, forming a crescent shaped anchor. The profile may resemble an archery bow under tension, for example. In some embodiments, the first arm and the second arm curve outward from the internal bend, and the internal bend curves inward. Any embodiments may include a high friction coating on an interior of at least one of the first arm and the second arm, such as the interior surface area that may or is likely to contact part of the rooftop wall or upper surface. In some embodiments, the second arm distal end may have a second tab having a second connection hole configured for connection to a ballast. The first arm and the second arm may be flat in some embodiments. The arms may be disposed of at an angle of between 85 degrees and 90 degrees relative to each other, joined at the internal bend. It should be appreciated that the lengths of the arms and the internal bend, the width of the arms and the bend, as well as the relative angles and curvature, may be determined for a particular embodiment by the person having an ordinary level of skill.

Some embodiments may take the form of a rooftop anchoring system. The system may comprise a plurality of non-penetrating roof bracket anchors. In some embodiments, non-penetrating roof bracket anchors may be the same. In other embodiments, there may be variations in the non-penetrating roof bracket anchors. Some embodiments may include one guy for each non-penetrating roof bracket anchor. Depending on the embodiment, there may be at least 3 non-penetrating roof bracket anchors. There may be 1 non-penetrating roof bracket anchor for each wall of the building or rooftop. For example, there may be 3, 4, 5, or more non-penetrating roof bracket anchors.

Some embodiments may take the form of a method of securing a structure on a rooftop. The structure may be connected to one end of a guy, and there may be, for example, one for each wall of the rooftop. The other end of the guy may be attached to a non-penetrating roof bracket anchor as described herein. In some embodiments, one or more non-penetrating roof anchors may have a lower arm connected to a ballast over the edge of the roof to provide additional stability.

These and other embodiments should be appreciated from this disclosure, the accompanying drawings, and the claims appended hereto. It should be appreciated that other embodiments may be practiced without departing from the present approach.

### DESCRIPTION OF THE DRAWINGS

FIG. 1 shows an L-shaped bracket anchor according to one embodiment of the present approach.

FIGS. 2A and 2B show an embodiment of a bracket anchor being used to secure a guy rope (A) on a flat roof, and (B) on a parapet, respectively.

FIG. 3 shows an embodiment of a bracket anchor in use with ballast.

FIG. 4A shows one embodiment of a crescent-shaped anchor bracket, and FIG. 4B shows an embodiment with a high friction coating. FIG. 4C illustrates an example of a crescent shaped bracket anchor positioned over a corner of rooftop.

FIGS. 5A and 5B show the typical geometry of a roof-mounted communications tripod according to one embodiment of the present approach, with FIG. 5A showing an elevation view, and FIG. 5B showing a plan view.

### DESCRIPTION

The following description is of the best currently contemplated modes of carrying out exemplary embodiments of the present approach. The description is not to be taken in a limiting sense and is made merely for the purpose of illustrating the general principles of the present approach.

As used herein, the phrase “rooftop anchoring system” means a combination of components that, when properly assembled, anchor a rooftop-mounted structure on the roof. A rooftop anchoring system according to the present approach will include a plurality of “non-penetrating roof anchor brackets,” described herein, configured to abut a roof edge or parapet edge and provide an outward force to stabilize and support a rooftop-mounted structure through one or more tethers, such as a guy. The phrase “rooftop-mounted structure” broadly refers to structures that are placed (or intended to be placed) on a rooftop, and protrude upwards from the rooftop. To counter wind effects, a rooftop-mounted structure normally requires an anchoring system to keep the structure in the desired position and supported while on the roof, and often is designed to be a temporary structure. Non-limiting examples of rooftop-mounted structures include vertical antenna arrays, communications equipment, radar and other sensor equipment, tripods that support a payload, and vertical masts that support a payload. A “guy” includes a guy wire, guy line, and a guy rope, and is a tensioned cable designed to add stability to a structure. Other terms are used as they would be understood by those having an ordinary level of skill in the art, in view of this disclosure and the accompanying drawings and claims.

Some embodiments of the present approach may take the form of a non-penetrating bracket that may be used in a roof anchoring system for a rooftop-mounted structure. An inverted L-shaped bracket anchor may be placed over the edge of a flat roof or parapet such that its internal bend abuts the roof edge or parapet edge, with one arm of the bracket horizontal, pointing inwards away from the roof edge, the other arm vertical, pointing downwards. Four such brackets, disposed orthogonally on the four roof edges of a square or rectangular building, may be used to anchor guy ropes attached to the top of a rooftop-mounted structure, such as a tripod. Ideally, the tripod should be located at the geometric center of the building roof to equalize guy rope angles on opposite sides. Of course, it should be understood that the present approach may be used to support a non-centered rooftop-mounted structure.

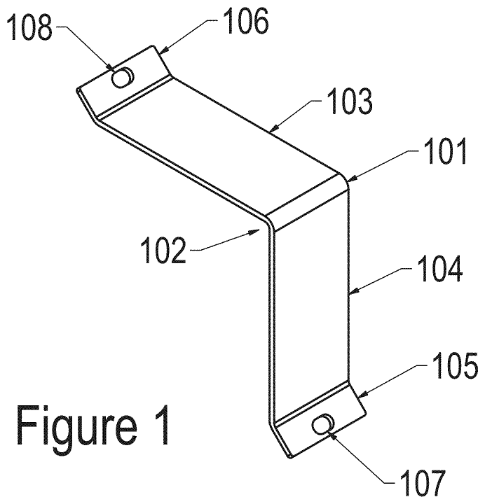

FIG. 1 shows an L-bracket anchor 101 having an internal bend 102 with an angle of 90 degrees and horizontal arm 103 and vertical arm 104 of equal length. This embodiment is shown with an internal bend 102 angle of 90 degrees, but it should be appreciated that the internal angle in other embodiments may be at least about 85 degrees (e.g., 85±about 0.1 degree), and not exceed 90 degrees (e.g., up to about 89.8 degrees, ±about 0.1 degree), and in some embodiments are between 85 degrees and 89.8 degrees (±about 0.1 degree), such as and including 85 degrees, 86 degrees, 87 degrees, 88 degrees, and 89 degrees, as well as the ranges between these values, which may be expressed in 0.1 degree increments. Internal angles larger than about 90 degrees run the risk of insufficiently anchoring the anchor over the roof edge or parapet. Internal angles smaller than 90 degrees may be used, particularly where the anchor is designed to have some flexion under load. However, angles less than about 85 degrees may exhibit reduced load-bearing capacity. Short tabs 105 and 106 at the distal end of each arm are provided with connection holes 107 and 108 to permit attachment of a connection mechanism, such as a snap hook, carabiner, hook clip, bolt assembly, or other connection mechanisms as are known in the art. A tab may be formed by bending a length of the bracket in a direction opposite of the internal angle. The tab length may be selected based on the size of the connection hole required for the particular embodiment. The tab bend angle may be sharp or gradual. A guy may also be attached using a suitable knot or, in case of a guy wire, a crimped termination. It should be appreciated that tabs 105 and 106 may be configured for connection with a particular connection mechanism, without departing from the present approach. In some embodiments, the tabs may be bent at an angle from the arm, in a direction opposite of the internal bend. The purpose of the tabs is to prevent contact between the connection mechanism and the building, which would otherwise tend to pry the bracket away from the vertical and horizontal surfaces of the building, reducing holding power. Alternatively, other connection mechanisms may be used, provided that they prevent contact between the connection mechanism and the building. The bracket may be symmetrical about its central bend (i.e., the intersection of arms 103 and 104), which may be useful to avoid ambiguity during installation. Some embodiments may include marking, such as labels, on the anchor to identify the horizontal and vertical arms. The bracket should be fabricated from one or more strong materials (typically steel or aluminum, although other materials known in the art may be used without departing from the present approach) and be sufficiently robust to resist the wind forces acting on the tripod and its payload.

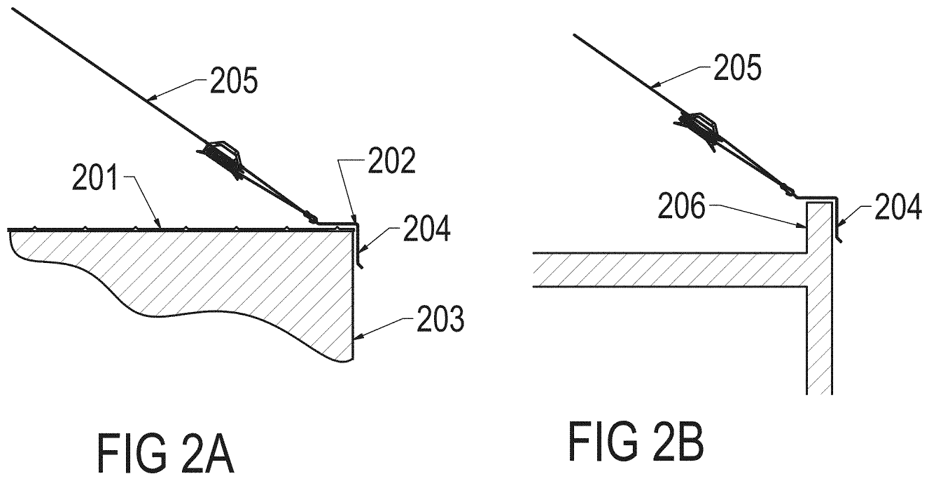

FIG. 2A shows the flat roof 201 of a building, with a right-angle corner 202 where the roof edge meets the outer wall of the building 203. An embodiment of the bracket anchor 204 is shown with the internal bend placed firmly up against the corner 202, such that the horizontal arm is generally parallel with the rooftop and the vertical arm is generally perpendicular to the rooftop, and is secured in place with a guy rope 205. The other end of the guy rope is attached to the top of a rooftop-mounted structure (not shown), such as a tripod, or its payload support.

FIG. 2B shows the same general arrangement from FIG. 2A, in use on a structure having a parapet 205. It should be appreciated that the present approach may be used on a building having a combination of right-angle corners, such as shown in FIG. 2A, and parapets, such as shown in FIG. 2B.

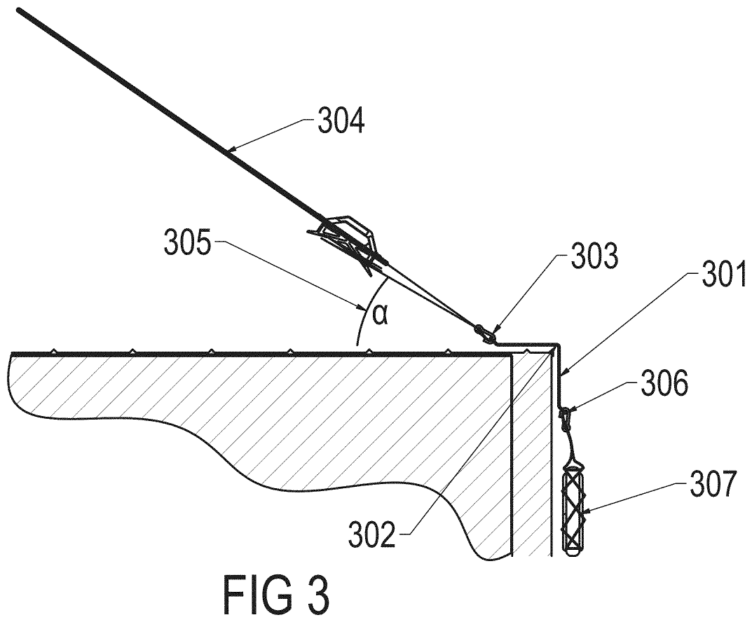

FIG. 3 shows an embodiment of an L-bracket anchor 301 on the corner 302 formed between the building roof and outer wall and held there by snap hook (or other connection mechanism) 303 and guy rope 304. Angle α 305 between the guy rope and horizontal is dependent on the distance of the rooftop-mounted structure (e.g., tripod, or other structure) from the edge of the roof and the height of the guy rope attachment point on the rooftop-mounted structure. In some embodiments, a ballast 307 may be used to increase the holding power of anchor 301. For example, an improvement in holding power may be obtained when a snap hook 306 (or other connection mechanism) is used to attach sandbag ballast 307 (or other ballast) to the distal end of the vertical arm of the bracket. It should be appreciated that the need for a ballast is highly dependent on the particular rooftop-mounted structure, the roof, and expected wind conditions, and that the person of ordinary skill in the art should be capable of determining the need for ballasting.

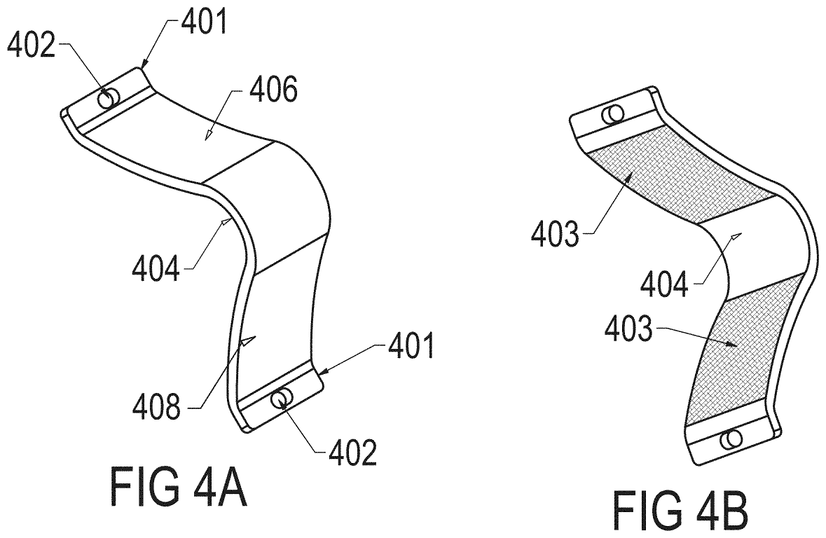

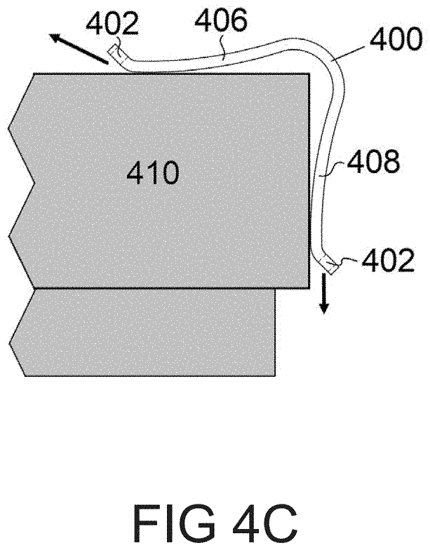

FIGS. 4A and 4B show embodiments of a second bracket anchor according to the present approach. These embodiments are approximately crescent shaped, and are referred to as such based on the general profile as can be seen in FIGS. 4A and 4B. Crescent shaped anchors according to the present approach have a pair of arms connecting at an arcuate internal bend 404, and in some embodiments either or both of upper arm 406 and lower arm 408 may gradually curve outward in a shallow curve. For example, the arms may curve outward from the internal bend, while the internal bend is arcuate inward, forming a shape that resembles an archery bow under tension. Arms 406 and 408 may terminate in tabs 401, and each tab may feature a connection hole 402 for mating with a corresponding connection mechanism, such as those described above. The bend radius of internal bend 404 may be chosen to prevent interference with typical architectural trim frequently used on the edges of flat roofs. It should be appreciated that those having an ordinary level of skill in the art should be able to determine the bend radius for a particular embodiment. As can be seen in FIG. 4A, the arms 406 and 408 bend at tabs 401, such that tabs 401 are generally co-planar in this embodiment. It should be appreciated that co-planar tabs are not required in all embodiments of crescent shaped anchors. Tabs may have a sharper bend in a direction opposite the internal bend. Crescent shaped anchors of the present approach have a number of advantages compared to the simple L-bracket, discussed below, although the method of use is generally similar to that described above for the L-bracket anchor.

When a crescent shaped anchor is properly placed over the edge of the roof or parapet, such that the arms are symmetrical with regard to the edge, the attachment tabs 401 assume an attitude of approximately 45 degrees to the horizontal. It should be appreciated that the attitude may not be precisely 45 degrees, and may be, for example, 42 degrees, 43 degrees, 44 degrees, or within the range of 42 degrees to 45 degrees, all to the horizontal. FIG. 4C illustrates an example of a crescent shaped bracket anchor 400 positioned over a corner of rooftop 410. It should be appreciated that bracket anchor 400 in FIG. 4C is shown at rest, i.e., there are no loads acting upon either upper arm 406, or lower arm 408. Upper arm 406 is positioned along the top surface, and lower arm 408 is positioned along an outer wall surface. At rest, the shape of the internal bend remains unchanged. However, a guy under load connected to each connection hole 402 applies a force in the general directions as shown by the arrows. Under a sufficient load (e.g., on either or both upper arm 406, or lower arm 408), the internal bend may deform to slightly increase the opening angle and the lengths of either or both the upper arm 406 and the lower arm 408. The surface area of the arms in contact with the rooftop and wall increases with the deformation, increasing the frictional forces acting to maintain the crescent shaped anchor in position. As a result, the crescent shaped anchor is especially well-suited for securing large structures on rooftops as described herein. Note that the connection holes 402 may be, in the illustrated embodiments in FIGS. 4A and 4B, elongated slots to permit attachment of at least two snap hooks (or other corresponding connection mechanisms). Of course, a variety of connection mechanisms are known in the art and may be used without departing from the present approach.

Compared to the L-shaped anchor bracket, the curvilinear shape of the crescent shaped bracket provides significantly better deformation resistance under heavy load, while grip at higher guy rope angles and tensions is also improved. The curve of the bend and the arms provides a change of angle of the extremities of the bracket equivalent to the 90 degree change more obviously present in the L-bracket. In practice, an angle of slightly less than 90 degrees between the flat surfaces, and preferably between about 85 degrees and less than 90 degrees, as discussed above, leads to a bracket which inherently grips the building structure, an important convenience to the operator. The curved internal angle portion of the crescent shaped bracket may be designed to follow the are of a circle having a radius sufficient to provide clearance for typical architectural trim used on many flat roofed buildings. For example, common corner trim may extend from the outer corner by about 3 inches to about 4 inches, but may vary depending on the building style, building use, location or region, and other factors. The person having an ordinary level of skill in the art can select a curved internal angle portion adequate for an intended clearance range, without departing from the present approach.

The embodiment of FIG. 4C is shown with an internal bend angle approximating about 90 degrees, as can be seen with how the crescent shaped bracket anchor 400 is positioned over the corner of rooftop 410. It should be appreciated that the internal angle in other embodiments may be at least about 85 degrees (e.g., 85±about 0.1 degree), and not exceed 90 degrees (e.g., up to about 89.8 degrees, ±about 0.1 degree), and in some embodiments are between 85 degrees and 89.8 degrees (±about 0.1 degree), such as and including 85 degrees, 86 degrees, 87 degrees, 88 degrees, and 89 degrees, as well as the ranges between these values, which may be expressed in 0.1 degree increments. It should be appreciated that in some embodiments, a tab with a connection hole 402 may be present on either or both the upper arm 406 and the lower arm 408. In some embodiments, the upper arm 406 and the lower arm 408 each have a tab with a connection hole 402. In some embodiments, such tabs may be bent opposite the direction of the internal bend. The tab bend may be a sharp bend or a rounded bend. In some embodiments, the tab bend may be such that both tabs with a connection hole 402 are co-planar at rest. FIG. 4C illustrates an embodiment in which the tabs are co-planar at rest.

In operation, once a guy rope has been attached to a bracket of the present approach, the vertical arm of the bracket applies pressure to the side of the of the building away from the corner, which might otherwise easily crumble under high pressure resulting from a tight 90 degree bend and high wind loading. Also, when the large radius is under pressure in contact with the wall, as the guy force increases (due to increasing wind speed), the pressure increases and the shallow curve of the bracket arm becomes shallower, thus spreading the force out over a larger area of the wall. This is a significantly better chain of events than those that occur with the simple L-bracket, which acts differently as loads increase. With the L-bracket, the initial force is spread out over the entire area of the vertical arm, but, as force increases, the arm bends outwards in an arc, both reducing the contact area, and moving it further and further up the wall towards the corner, until the bracket starts to slip and is no longer effective, or until the wall starts to crumble.

In some embodiments, internal surfaces of the bracket may include a high friction coating to increase friction. FIG. 4B shows a high friction coating 403 applied to the internal surfaces of an embodiment of a crescent shaped bracket. As an example of a high friction coating, material used in a Spray-On Bed Lining, available from Scorpion Coatings, provides improved bracket anchor slip-resistance on low friction surfaces, such as the steel or aluminum sheathing used in architectural trim, especially when wet. Friction-coated, crescent-shaped embodiments of the present approach provide an excellent grip, even on a wet metal roof edge. At guy rope angles at and below 30 degrees to the horizontal, no additional ballast is required. Applying the high friction coating to internal surfaces of both arms effectively doubles the life of the coating, which tends to wear over time. It should be appreciated that other means of increasing friction on the internal surfaces may be used, including coatings available in the art, introducing scoring or other surface defects, and the like. In some embodiments, the rooftop and/or outer wall surfaces may receive a high friction coating or other treatment to increase friction. However, such treatment may cause undesirable damage to the structure.

Under high wind conditions, vibration of the guy rope may tend to cause slippage of the bracket. This undesirable effect is mitigated or eliminated when high modulus (low stretch) guy rope is used. An example of a suitable guy rope is the Quickie Rope Tie Down assembly, from Quickie Tie-Down Enterprises, which has a safe working load of 500 pounds, adequate for most applications of the bracket, is convenient to use, and utilizes a ⅜″ low-stretch rope which has proven, under test, to resist bracket slippage under strong wind conditions.

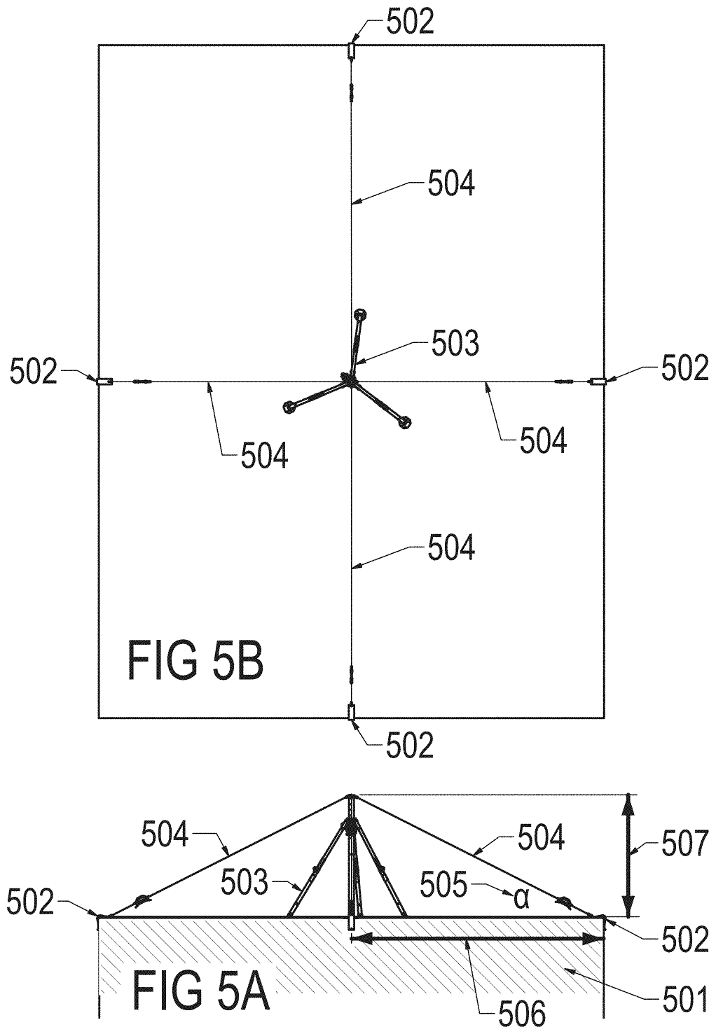

Some embodiments of the present approach may take the form of a non-penetrating rooftop anchor system having a plurality of brackets and guy ropes. FIG. 5A shows an elevation view of the upper part of a rectangular building 501 with embodiments of brackets 502 according to the present approach, anchoring a tripod 503 by means of guy ropes 504 connected to the top of the tripod. Alternatively, and depending on the particular rooftop-mounted structure, the guy ropes 504 may be connected to the communications equipment support structure at the top of the tripod. It should be apparent to one of ordinary skill in the art that the efficacy of the present approach depends in part on the angle alpha 505 that the guy rope makes with the horizontal. This angle depends on the distance 506 of the tripod 503 to the nearest edge of the building 501. In practice, it is found that the recommended maximum angle that can be used is 45 degrees, in which case the height of the guy rope attachment point is equal to the distance from the base of the tripod center. Some ballast, attached to the bracket anchor as shown in FIG. 3, may be required to prevent anchor slippage under strong wind conditions at a guy rope angle of 45 degrees. The amount of ballast required decreases as the guy rope angle decreases. In certain preferred embodiments, and in particular the crescent shaped anchor with a high-friction coating, no ballast is required once the angle reduces below 30 degrees. As a simple rule of thumb for operators, an angle less than 30 degrees is obtained when the distance of the tripod center to the closest roof edge is two times the height of the guy rope attachment point at the top of the tripod.

FIG. 5B shows the plan view of the tripod 503 on the rectangular building. Since the vast majority of buildings are rectangular in shape, there is usually a need to provide four roof anchors 502, and guy ropes 504 from the tripod 503 in the four directions necessary to permit the bracket anchor to be placed squarely on the edges of the roof.

The tripod stabilization effectiveness of the embodiment shown in FIGS. 5A and 5B may be judged by a simple comparison of the weight of ballast to the weight of equipment needed using the present approach. In the case of a 20 square foot payload at a height of 10′, each tripod foot requires over 500 pounds of ballast to prevent tip over at a wind speed of 80 mph, for a total ballast weight exceeding 1500 pounds. Assuming a guy angle of 30 degrees or less, the combination of the roof bracket and guy rope assemblies disclosed in FIGS. 5A and 5B weighs under ten pounds, for a total, assuming four guying directions, of less than 40 pounds.

It should be appreciated that embodiments of the present approach offer greatly improved holding power for rooftop-mounted structures, with significantly less weight and greater flexibility than contemporary solutions.

The terminology used in the description of embodiments of the present approach is for the purpose of describing particular embodiments only and is not intended to be limiting. As used in the description and the appended claims, the singular forms “a.” “an” and “the” are intended to include the plural forms as well, unless the context clearly indicates otherwise. The present approach encompasses numerous alternatives, modifications, and equivalents as will become apparent from consideration of the following detailed description.

It will be understood that although the terms “first.” “second.” “third.” “a),” “b).” and “c),” etc. may be used herein to describe various elements of the present approach, and the claims should not be limited by these terms. These terms are only used to distinguish one element of the present approach from another. Thus, a first element discussed below could be termed an element aspect, and similarly, a third without departing from the teachings of the present approach. Thus, the terms “first,” “second,” “third.” “a),” “b),” and “c),” etc. are not intended to necessarily convey a sequence or other hierarchy to the associated elements but are used for identification purposes only. The sequence of operations (or steps) is not limited to the order presented in the claims.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. All publications, patent applications, patents and other references mentioned herein are incorporated by reference in their entirety. In case of a conflict in terminology, the present specification is controlling.

Also, as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the present approach described herein can be used in any combination. Moreover, the present approach also contemplates that in some embodiments, any feature or combination of features described with respect to demonstrative embodiments can be excluded or omitted.

As used herein, the transitional phrase “consisting essentially of” (and grammatical variants) is to be interpreted as encompassing the recited materials or steps “and those that do not materially affect the basic and novel characteristic(s)” of the claim. Thus, the term “consisting essentially of” as used herein should not be interpreted as equivalent to “comprising.”

The term “about,” as used herein when referring to a measurable value, such as, for example, an amount or concentration and the like, is meant to encompass variations of ±20%, ±10%, ±5%, ±1%, ±0.5%, or even ±0.1% of the specified amount. A range provided herein for a measurable value may include any other range and/or individual value therein.

Having thus described certain embodiments of the present approach, it is to be understood that the scope of the appended claims is not to be limited by particular details set forth in the above description as many apparent variations thereof are possible without departing from the spirit or scope thereof as hereinafter claimed

What is claimed is:

1. A non-penetrating roof bracket anchor comprising:
a first arm having a first distal end with a first connection hole configured for connection to a guy, and a first proximal end terminating at an internal bend;
a second arm having a second distal end and a second proximal end terminating at the internal bend opposite the first arm;
wherein the internal bend is configured to abut an outer edge of one of a roof and a parapet, such that the first arm extends horizontally inward from the outer edge, and the second arm extends vertically downward from the outer edge.

2. The non-penetrating roof bracket anchor of claim 1, wherein the first arm has a first tab bent in a direction opposite of the internal bend and including the first connection hole.

3. The non-penetrating roof bracket anchor of claim 1, wherein the non-penetrating roof bracket anchor has an arcuate profile, forming a crescent shaped anchor.

4. The non-penetrating roof bracket anchor of claim 3, wherein the first arm and the second arm curve outward from the internal bend, and the internal bend curves inward.

5. The non-penetrating roof bracket anchor of claim 1, further comprising a high friction coating on an interior of at least one of the first arm and the second arm.

6. The non-penetrating roof bracket anchor of claim 4, further comprising a high friction coating on an interior of at least one of the first arm and the second arm.

7. The non-penetrating roof bracket anchor of claim 1, wherein the second arm distal end comprises a second tab having a second connection hole configured for connection to a ballast.

8. The non-penetrating roof bracket of claim 3, wherein the first arm and the second arm are flat and are disposed of at an angle of between 85 degrees and 90 degrees relative to each other.

9. The non-penetrating roof bracket anchor of claim 3, further comprising a high friction coating on an interior of at least one of the first arm and the second arm.

10. A rooftop anchoring system comprising:
a plurality of non-penetrating roof bracket anchors, each anchor having
a first arm having a first distal end with a first connection hole configured for connection to a guy, and a first proximal end terminating at an internal bend;
a second arm having a second distal end and a second proximal end terminating at the internal bend opposite the first arm;
each non-penetrating roof bracket anchor connected to an outer end of a guy;
each guy having an inner end configured to connect to a roof-mounted structure;
wherein the internal bend is configured to abut an outer edge of one of a roof and a parapet, such that the first arm extends horizontally inward from the outer edge, and the second arm extends vertically downward from the outer edge.

11. The rooftop anchoring system of claim 10, wherein the first arm of at least one non-penetrating roof bracket anchors has a first tab bent in a direction opposite of the internal bend and including the first connection hole.

12. The rooftop anchoring system of claim 10, wherein at least one non-penetrating roof bracket anchor has an arcuate profile, forming a crescent shaped anchor.

13. The rooftop anchoring system of claim 12, wherein the first arm and the second arm curve of the at least one non-penetrating roof bracket anchor outward from the internal bend, and the internal bend curves inward.

14. The rooftop anchoring system of claim 12, further comprising a high friction coating on an interior of at least one of the first arm and the second arm of the at least one non-penetrating roof bracket anchor.

15. The rooftop anchoring system of claim 10, wherein the second arm distal end comprises a second tab having a second connection hole configured for connection to a ballast.

16. The rooftop anchoring system of claim 12, wherein the first arm and the second arm are flat and are disposed of at an angle of between 85 degrees and 90 degrees relative to each other.

17. The rooftop anchoring system of claim 10, further comprising a high friction coating on an interior of at least one of the first arm and the second arm of at least one non-penetrating roof bracket anchor.

18. The rooftop anchoring system of claim 12, further comprising a high friction coating on an interior of at least one of the first arm and the second arm of at least one non-penetrating roof bracket anchor.

19. The rooftop anchoring system of claim 10, comprising at least 3 non-penetrating roof bracket anchors.

20. The rooftop anchoring system of claim 19, wherein each non-penetrating roof bracket anchor is identical.
